(19) United States
(12) Patent Application Publication
(10) Pub. No.: US 2016/0370520 A1
(43) Pub. Date: Dec. 22, 2016

(54) OPTICAL ELEMENT, OPTICAL SYSTEM AND OPTICAL APPARATUS USING MULTI-LAYER FILM

(71) Applicant: CANON KABUSHIKI KAISHA, Tokyo (JP)

(72) Inventor: Daisuke Sano, Moka-shi (JP)

(21) Appl. No.: 15/176,743

(22) Filed: Jun. 8, 2016

(30) Foreign Application Priority Data
Jun. 18, 2015 (JP) 2015-122941

(51) Int. Cl. G02B 5/28; G02B 21/16

(52) U.S. Cl. CPC G02B 5/289; G02B 21/16

(57) ABSTRACT

An optical element 100 includes a substrate 102, and a multi-layer filter stacked on the substrate. When, of two materials having mutually different refractive indexes, a film formed of a material having a higher refractive index is an H-film and a film formed of a material having a lower refractive index is an M-film, the multi-layer films includes a plurality of H-films and M-films. When one of the H-film and the M-film is a first film and a wavelength of light incident to the multi-layer film is λ(nm), optical thickness of the first film repeats an increase/decrease so that an increase/decrease amount varies, a maximum value of the increase/decrease amount is equal to or more than λ/10, a minimum value of the increase/decrease amount is equal to or less than λ/15, and total film numbers of the H-film and the M-film are from 30 to 1000.

### BACKGROUND OF THE INVENTION

### Field of the Invention

The present invention relates to an optical element such as an optical filter using a multi-layer film.

### Description of the Related Art

Optical filters have been used as ND filters to attenuate intensity of incident light and polarization filters to selectively perform reflection and transmission according to incident polarized light. Such optical filters are incorporated in optical apparatuses such as cameras and optical measuring apparatuses.

Japanese Patent Laid-Open No. (“JP”) 2009-294662 discloses a rugate filter as one of optical filter. Rugate filters are optical filters to selectively perform reflection and transmission according to a wavelength of light. Rugate filters do not generate characteristic variations (ripple) in a transmitting wavelength band unlike a dichroic filter having the same function. Accordingly, rugate filters have been widely utilized for optical apparatuses precisely obtaining a plurality of wavelengths such as fluorescence microscopes and optical communication applications. Rugate filters are formed by stacking a plurality of optical thin films.

However, the rugate filter disclosed in JP 2009-294662 is manufactured by a special method stacking the optical thin films while continuously and periodically varying a refractive index in a lamination direction and thus, a special manufacturing apparatus is required.

### SUMMARY OF THE INVENTION

The present invention provides an optical apparatus having the same optical function as a rugate filter without requiring a special manufacturing method and a special manufacturing apparatus.

An optical element according to one aspect of the present invention includes a substrate, and a multi-layer filter stacked on the substrate. When, of two materials having mutually different refractive indexes, a film formed of a material having a higher refractive index is an H-film and a film formed of a material having a lower refractive index is an M-film, the multi-layer films includes a plurality of H-films and M-films. When one of the H-film and the M-film is a first film and a wavelength of light incident to the multi-layer film is A(nm), optical thickness of the first film repeats an increase/decrease so that an increase/decrease amount varies, a maximum value of the increase/decrease amount is equal to or more than λ/10, a minimum value of the increase/decrease amount is equal to or less than λ/15, and total film numbers of the H-film and the M-film are from 30 to 1000.

Further features and aspects of the present invention will become apparent from the following description of exemplary embodiments with reference to the attached drawings.

### BRIEF DESCRIPTION OF THE DRAWINGS

FIG. 1 is a sectional view of a multi-layer optical element according to embodiments of the present invention.

FIG. 2 is a chart illustrating a film configuration of an optical element according to a first embodiment.

FIG. 3 is a chart illustrating reflectance characteristics of the optical element according to the first embodiment.

FIG. 4 is chart illustrating thickness variations.

FIG. 5 is an explanatory view of an equivalent film theory.

FIG. 6 is a chart illustrating an example of refractive index dispersion of an equivalent film.

FIG. 7 is an example of dispersion of physical thickness of the equivalent film.

FIG. 8 is a chart illustrating equivalent film conversion for one layer according to the first embodiment.

FIG. 9 is a chart illustrating a film configuration of an optical element according to a second embodiment.

FIG. 10 is a chart illustrating reflectance characteristics of the optical element according to the second embodiment.

FIG. 11 is a chart illustrating a film configuration of an optical element according to a third embodiment.

FIG. 12 is a chart illustrating reflectance characteristics of the optical element according to the third embodiment.

FIG. 13 is a chart illustrating a film configuration of an optical element according to a fourth embodiment.

FIG. 14 is a chart illustrating reflectance characteristics of the optical element according to the fourth embodiment.

FIG. 15 is a schematic diagram illustrating a fluorescence microscope using the optical element according to the embodiments.

### DESCRIPTION OF THE EMBODIMENTS

Exemplary embodiments of the present invention will be described below with reference to the accompanied drawings.

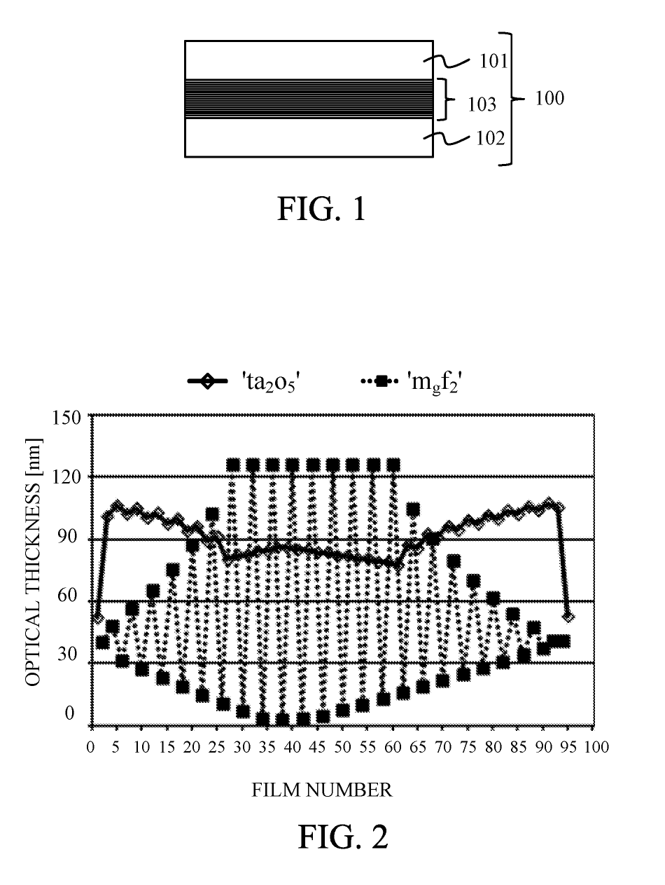

First, common subject matters of first to fourth embodiments described below will be specifically explained. FIG. 1 illustrates a common configuration of an optical element according to each embodiment of the present invention.

An optical element 100 includes a supporting substrate 102, a multi-layer film portion 103 formed by stacking a plurality of thin films on the supporting substrate 102, and an incident substrate 101 covering a surface (light incident surface) of the multi-layer film portion 103 opposite to a surface on a supporting substrate 102 side. However, the incident substrate 101 may not be necessarily provided. Additionally, in the embodiments, a thin film means a film utilizing optical interference, and more particularly, a film having optical thickness that is equal to or less than several times of an incident wavelength.

The multi-layer film portion 103 selectively performs reflection and transmission according to a wavelength of incident light. Reflection utilizing a multi-layer film can be realized by making optical thickness of each thin film λ/4 while repeatedly increasing or decreasing reflectance relative to a wavelength λ(nm) to be reflected as multi-layer film mirrors

In general rugate filters, a multiple-layer films is formed while modulating a refractive index of each thin film (varying continuously and periodically) so as to suppress large ripples generated in a wavelength band to be transmitted. However, rugate filters can reduce an occurrence of ripples, but large thin film numbers (total film numbers) are required to increase reflection efficiency. Moreover, though several ways, such as selecting a predetermined material or utilizing a multi-component vapor deposition method, can modulate a refractive index of a thin film, but a selectable thin film material is limited, and further, does not always have a desirable refractive index. Accordingly, conventional rugate filters have been typically manufactured using the multi-component vapor deposition method. The multi-component vapor deposition method is a method that adjusts a compounding ratio of a plurality of vapor deposition materials while forming the vapor deposition materials at the same time so as to obtain a film having an arbitrary refractive index. The refractive index of the obtained film is interpolated between refractive indexes of the vapor deposition materials. However, the multi-component vapor deposition method requires an extremely complicated manufacturing process that varies the compounding ratio while forming thin films in a vacuum. A special manufacturing apparatus that includes a mechanism varying the compounding ratio and a mechanism monitoring a refractive index is also required. As described above, manufacturing conventional rugate filters using the multi-component vapor deposition method is difficult.

Meanwhile, in the embodiments, only stacking two types of thin films respectively formed of two materials in a thickness direction (layer thickness direction) while adjusting optical thickness can provides a multi-layer film having the same characteristics as rugate filters. Since controlling thickness of two materials is much easier than adjusting a refractive index, the optical elements according to the embodiments can be easily manufactured.

In the embodiments, the multi-layer film portion 103 is formed by stacking a plurality of H-films formed of a material having a higher refractive index of two materials mutually having different refractive indexes and a plurality of M-films formed of a material having a lower refractive index of two materials on a substrate (supporting substrate 102). A wavelength of light incident on the multi-layer film portion 103 through the incident substrate 101, which is an incident medium, is an use wavelength (designed wavelength).

Furthermore, in the embodiments, one of the H-film and the M-film, which are two types of thin films, is a first film. As one of characteristics of the first film, of an increase/decrease amount of optical thickness that varies by repeatedly increasing or decreasing optical thickness from the support substrate 102 side (substrate side) to an incident substrate 101 side (incident medium side), a maximum value is equal to or more than λ/10, and a minimum value is equal to or less than λ/15. Hereinafter, having the above characteristics is referred to as a condition 1. Further, total film numbers of the H-films and the M-films of the multi-layer film portion 103 are characteristically from 30 to 1000. Hereinafter, having the above characteristic is referred to as a condition 2. In the following explanation, a film is also called a layer.

### First Embodiment

Hereinafter, an optical element 100 according to a first embodiment will be specifically explained, and the common subject matters of the first to fourth embodiments will be also explained.

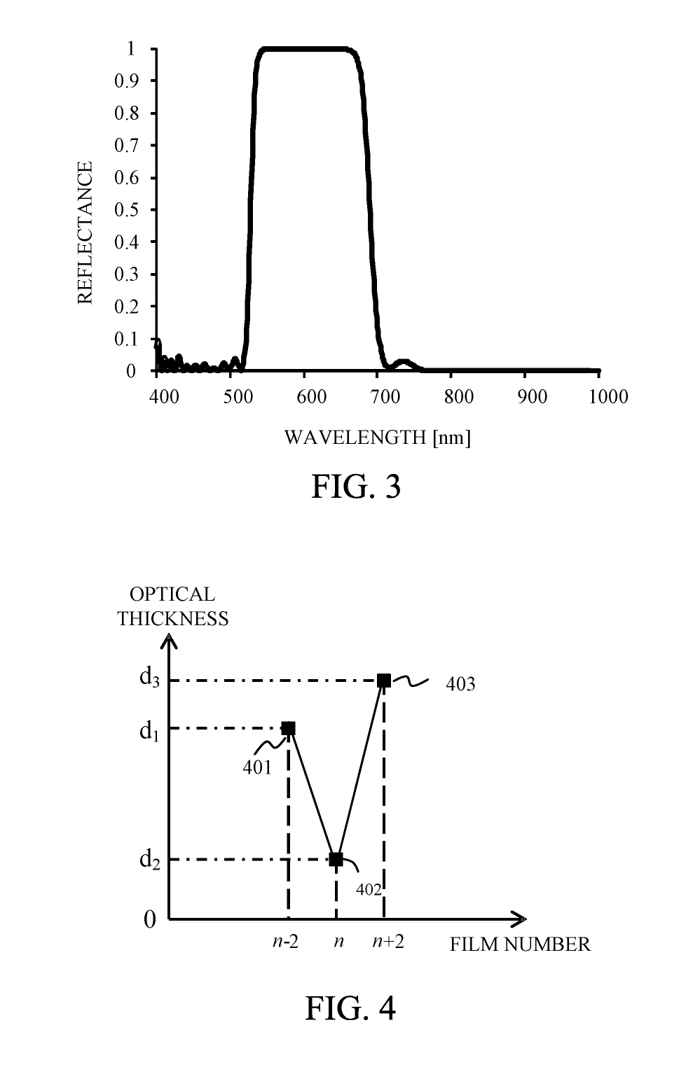

FIGS. 2 and 3 respectively illustrate a film configuration of a multi-layer film portion 103 of the optical element 100 according to the first embodiment and reflectance characteristics. A central wavelength λ_{d} (hereinafter, referred to as “an use central wavelength”) in an use wavelength is 600 nm, Ta₂O₅ is used as a material of an H-film (H-layer) of the multi-layer film portion 103 and MgF₂ is used as a material of an M-film (M-layer) of the multi-layer film portion 103. Refractive indexes of the H-film and the M-film with respect to the central wavelength λ_{d} are respectively 2.194 and 1.380. Besides, a glass having a refractive index of 1.80 is used for the incident substrate 101 and the supporting substrate 102.

In FIG. 2, an abscissa axis represents a film number for each thin film numbered from the supporting substrate 102 to the incident substrate 101, and an ordinate axis represent optical thickness of each thin film. Void lozenged plot points represent optical thickness of the H-film (Ta₂O₅), and black square plot points represent optical thickness of the M-film (MgF₂). The H-film is optically adjacent to the incident substrate 101 and the supporting substrate 102, and the H-film and the M-film are alternately stacked in a thickness direction.

The following presents a ratio of optical thickness of each film in FIG. 2 to the central wavelength λ_{d}. A value added a sign H is ratio of optical thickness of the H-film to the central wavelength λ_{d} and a value added a sign M is ratio of optical thickness of the M-film to the central wavelength λ_{d}.

0.087H,0.067M,0.168H,0.08M,0.177H,0.052M,0.17H,0.094M,0.175H,0.045M,0.167H,0.108M,0.171H,0.038M,0.162H,0.125M,0.166H,0.031M,0.156H,0.145M,0.16H,0.024M,0.148H,0.17M,0.152H,0.018M,0.134H,0.209M,0.137H,0.011M,0.137H,0.209M,0.141H,0.005M,0.141H,0.209M,0.143H,0.005M,0.143H,0.209M,0.142H,0.006M,0.142H,0.209M,0.139H,0.008M,0.139H,0.209M,0.137H,0.012M,0.137H,0.209M,0.134H,0.017M,0.134H,0.209M,0.132H,0.021M,0.132H,0.209M,0.129H,0.026M, 0.145H,0.174M,0.143H,0.031M,0.154H,0.151M,0.151H,0.036M, 0.16H,0.132M,0.157H,0.041M,0.165H,0.117M,0.162H,0.046M, 0.169H,0.103M,0.166H,0.051M,0.173H,0.09M,0.17H,0.057M, 0.176H,0.079M,0.173H,0.062M,0.179H,0.068M,0.175H,0.068M, 0.088H.

As illustrated in FIG. 3, the multi-layer film portion 103 according to this embodiment has filter characteristics that reflects light of a reflection wavelength band of 520 nm to 700 nm and transmits light of the other wavelength band. Ripples in a transmissive wavelength band are suppressed to 10% or less, and the multi-layer film portion 103 has the same function as rugate filters.

The H-film, the M-film, the incident substrate 101, and the supporting substrate 102 according to this embodiment have positive dispersion. Table 1 provides each dispersion value. Additionally, each coefficient is calculated using the following Hartmann dispersion formula (1).

TABLE 1

| | RNL | AV | RLV |
|---|---|---|---|
| H-layer Ta₂O₅ | 2.0909 | 39.532 | 215.75 |
| M-layer MgF₂ | 1.3700 | 5.000 | 120.00 |
| Substrates 101, 102 | 1.7572 | 25.188 | 89.50 |

$$n ( λ ) = RNL + \frac{AV}{λ - RLV} \qquad ( 1 )$$

Herein, the use wavelength λ is expressed with nm as a unit. A refractive index n(λ) relative to an arbitrary wavelength is expressed by the expression (1), but it is required that λ is larger than RLV.

The condition 1 according to this embodiment will be explained. Increasing or decreasing optical thickness in the condition 1 is determined by comparing materials (thin films) having the same refractive index. Thus, comparing using a graph of FIG. 2 plotting variations of optical thickness of a material having the same refractive index from the supporting substrate 102 side is required. In this comparison, when having the same refractive index (or different refractive indexes being substantially equal), different materials are regarded as the same. The condition to regard as the same material, for example, may be that differences between refractive indexes relative to the use central wavelength λ_{d} are equal to or less than 0.02.

In this embodiment, the first film is the M-film (MgF₂). An increase/decrease amount of optical thickness of the M-film gradually increases from a film number of 2 close to the supporting substrate 102 to a film number of 94 close to the incident substrate 101, and decreases after gradually increasing. FIG. 4 illustrates an increase/decrease of optical thickness 401, 402 and 403 among three successive thin films of the same material (numbers n−2, n and n+2 represent film numbers of the same material, and numbers n−1 and n+1 represent film numbers of a different material). Increasing or decreasing optical thickness means variation of optical thickness in such a way as large to small to large or small to large to small as the optical thickness 401, 402 and 403.

The increase/decrease amount of optical thickness is an average of differences of optical thickness among three successive thin films of the same material as illustrated in FIG. 4. In particular, the increase/decrease amount of optical thickness is an average of differences (d1−d2) between the optical thicknesses 401 and 402 of a first layer (n−2) and a second layer (n) and differences (d3−d2) between the optical thicknesses 402 and 403. In this embodiment, only one thin film made from a different material is formed among thin films formed of the same material, but two or more thin films made from a different material may be formed.

Minimum and maximum values of the increase/decrease amount of optical thickness of the M-film (MgF₂) in FIG.2 are respectively 6.7 nm among the film numbers 88, 90 and 92 and 122.8 nm among the film numbers 36, 38 and 40. Since the use central wavelength λ_{d} is 600 nm, the minimum and maximum values are respectively λ_{d}/15 or less and λ_{d}/10 or more. In other words, the condition 1 is satisfied.

In this embodiment, total film numbers are 95 and the condition 2 that total film numbers are from 30 to 1000 is satisfied. Increasing total film numbers is effective to enhance reflectance with respect to the reflection wavelength band in the filter application of this embodiment. In addition, stacking efficiency in the reflection wavelength band lowers to decrease ripples in the transmissive wavelength band. Low stacking efficiency means that differences between refractive indexes of the virtually stacked multi-layer film are small. In other words, this means that an increasing effect of reflectance by a lamination is small. Accordingly, if total film numbers are less than 30, desirable characteristics failed to be obtained. If total film numbers are more than 1000, a stack is a state that reflectance with respect to the reflection wavelength band reaches 100% and thus, ripples undesirably increases. For this reason, satisfying the condition regarding total film numbers is required. The total film numbers are preferably equal to or more than 50, and are more preferably equal to or more than 60.

The following is a basic concept to obtain characteristics being a target of this embodiment. General rugate filters have roughly two characteristics. One is that a refractive index is slightly varied and the other is that optical thickness of each film is λ/4. The former suppresses the ripples in the transmissive wavelength band and the latter increases reflectance in the reflection wavelength band.

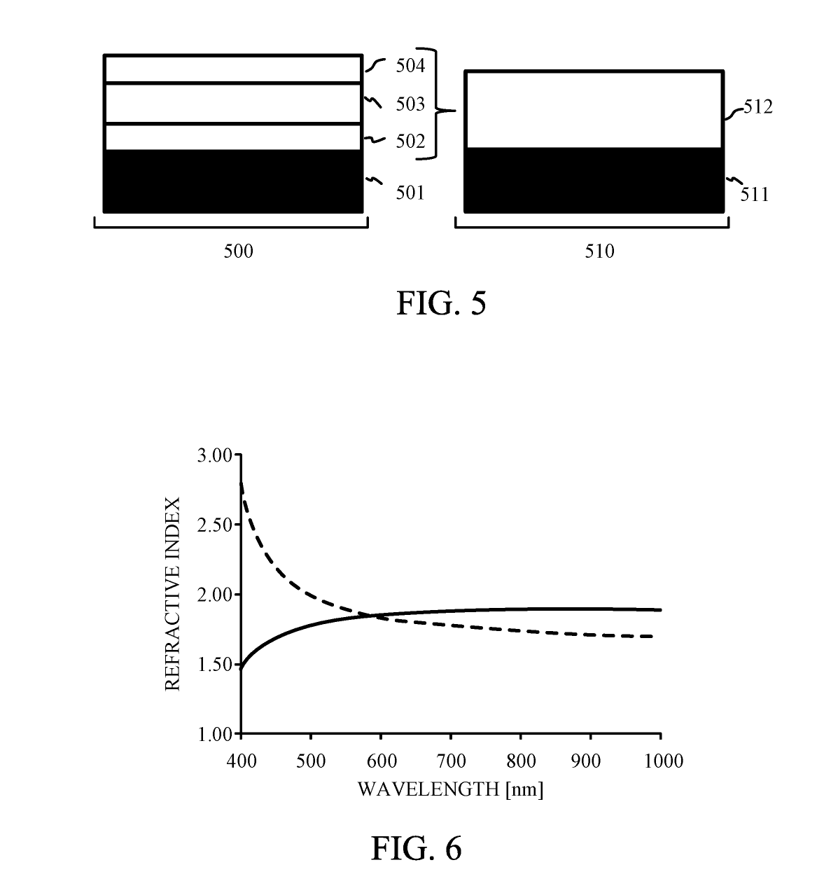

In this embodiment, the multi-layer film portion 103 is designed by extending an equivalent film theory on the basis of the above concept. The equivalent film theory will be explained referring to FIG. 5. Reference numerals 500 and 510 denote optical elements, and 501 and 511 substrates. Reference numerals 502, 503, 504 and 512 denote thin films. The optical element 500 includes a multi-layer film formed of the three thin films 502, 503 and 504. Meanwhile, the optical element 510 includes only the one thin film 512.

When the thin films 502 and 504 of the optical element 500 have the same refractive index and the same thickness, it is known that the optical elements 500 and 510 indicate the same feature. Extending it to a wavelength and a propagation angle can obtain the following expressions (2) to (6).

$$\begin{matrix}{U}_{T}^{2} = {U}_{1}^{2} \frac{2 {U}_{1} {U}_{2} tan {Δ}_{1} + {U}_{2}^{2} tan {Δ}_{2} - {U}_{1}^{2} {tan}^{2} {Δ}_{1} tan {Δ}_{2}}{2 {U}_{1} {U}_{2} tan {Δ}_{1} + {U}_{1}^{2} tan {Δ}_{2} - {U}_{2}^{2} {tan}^{2} {Δ}_{1} tan {Δ}_{2}} & ( 2 ) \\ sin {Δ}_{T} = {U}_{T} ( \frac{2}{{U}_{1}} cos {Δ}_{1} sin {Δ}_{1} cos {Δ}_{2} + \frac{{U}_{1}^{2} {cos}^{2} {Δ}_{1} - {U}_{2}^{2} {sin}^{2} {Δ}_{1}}{{U}_{1}^{2} {U}_{2}} sin {Δ}_{2} ) & ( 3 ) \\ cos {Δ}_{T} = {cos}^{2} {Δ}_{1} cos {Δ}_{2} - {sin}^{2} {Δ}_{1} cos {Δ}_{2} - \frac{{U}_{1}^{2} + {U}_{2}^{2}}{{U}_{1} {U}_{2}} cos {Δ}_{1} sin {Δ}_{1} sin {Δ}_{2} & ( 4 ) \\ {U}_{T , 1 , 2} = \{ \begin{matrix}{n}_{T , 1 , 2} cos {θ}_{T , 1 , 2} & S poralization \\ \frac{{n}_{T , 1 , 2}}{cos {θ}_{T , 1 , 2}} & P poralization\end{matrix} & ( 5 ) \\ {Δ}_{T , 1 , 2} = \frac{2 π}{{λ}_{i}} {n}_{T , 1 , 2} {d}_{T , 1 , 2} cos {θ}_{T , 1 , 2} & ( 6 )\end{matrix}$$

In the above expressions (2) to (6), n is a refractive index, d is physical thickness, θ is an angle (propagation angle) of light propagating in a film, and the angle θ can be obtained from Snell's law and an incident angle of light. The incident angle is an angle of light incident to the thin film being the outmost surface of the multi-layer film portion 103 of the optical element 100 and is a central incident angle of the incident light. The left-side value of the expression (6) is a quantity referred to as phase thickness of each thin film. Subscripts of variables represent the thin films, and the number “1” is the thin films 502 and 504 and the number “2” is the thin film 503. The symbol “T” is the thin film 512. Developing these expressions means obtaining the same characteristics of one film by stacking three thin films using two types of thin films respectively formed of two materials mutually having different refractive indexes. Assigning the variables U_{1,2} and Δ_{1,2} converted from the refractive indexes n₁ and n₂ and the physical thickness d₁ and d₂ of each thin film using the expressions (5) and (6) to the expressions (2) to (4) obtains the variables U_{T} and Δ_{T}, and the equivalent refractive index n_{T} and the equivalent physical thickness d_{T} can be calculated from the variables U_{T} and Δ_{T}.

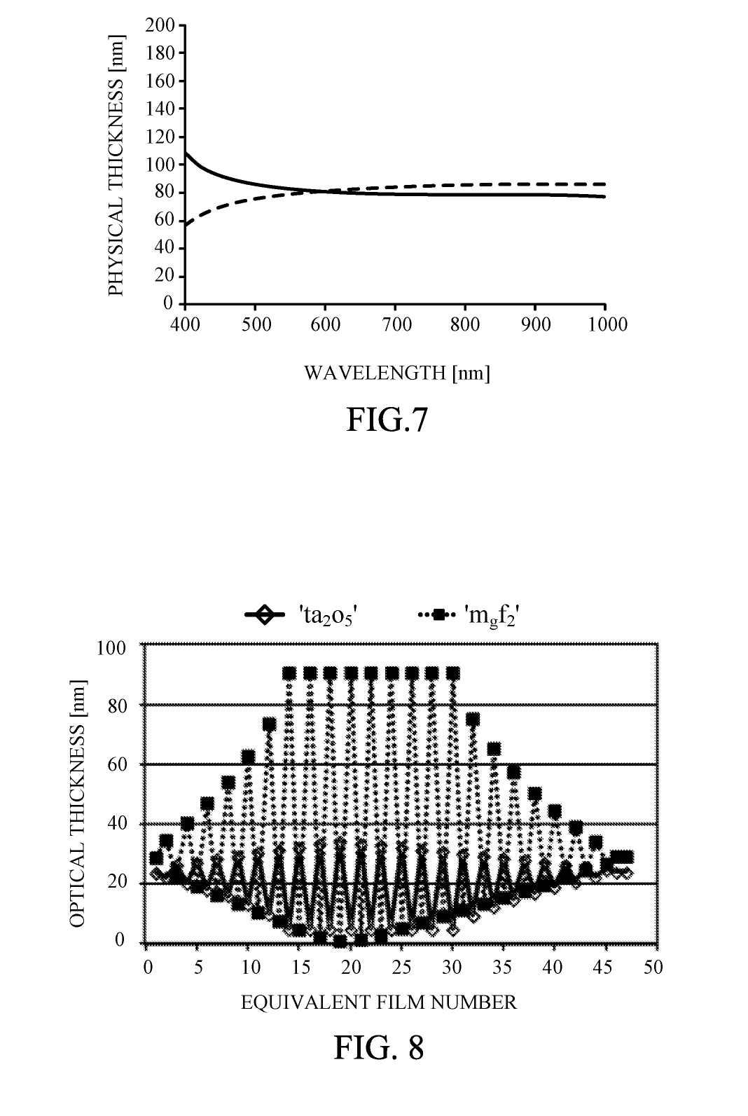

Tables (2) and (3) provide examples of film configurations including an equivalent refractive index (hereinafter referred to as “a refractive index”) n_{T} using the expressions (2) to (6), FIG.6 illustrates the refractive index n_{T}, and FIG. 7 illustrates equivalent optical thickness (hereinafter referred to as “physical thickness”) d_{T}. In FIGS. 6 and 7, solid lines are respectively the refractive index n_{T} and the physical thickness d_{T} of Table 2, and broken lines are respectively the refractive index n_{T} and the physical thickness d_{T} of Table 3. The film configurations of Tables 2 and 3 are designed so that the refractive index n_{T} relative to incident light incident at an incident angle of ris 1.840 and physical thickness d_{T} is 81.5 nm when an use wavelength (central wavelength) is 600 nm. The film configurations of Tables 2 and 3 are also configurations that materials of the thin films 502 and 504 and the thin film 503 are mutually shuffled.

TABLE 2

| | Refractive | Physical Thickness |
|---|---|---|
| | Index | [nm] |
| Incident Medium Air | 1 | |
| H-layer Ta₂O₅ | 2.194 | 30.0 |
| M-layer MgF₂ | 1.380 | 28.4 |
| H-layer Ta₂O₅ | 2.194 | 30.0 |
| Substrates 101, 102 | 1.807 | — |

TABLE 3

| | Refractive | Physical Thickness |
|---|---|---|
| | Index | [nm] |
| Incident Medium Air | | |
| M-layer MgF₂ | 1.380 | 25.2 |
| H-layer Ta₂O₅ | 2.194 | 26.1 |
| M-layer MgF₂ | 1.380 | 25.2 |
| Substrates 101, 102 | 1.807 | |

As it is evident from the FIG. 6, arrangement of materials (thin films) of Table 2 enormously enlarges dispersion of the refractive index n_{T}. Furthermore, physical thickness of a normal thin film is not varied, but physical thickness of the film configurations of Tables 2 and 3 varies. This means that thickness does not physically vary, but thickness for light, in other words, phase modulation quantity varies. Optical thickness (=refractive index x physical thickness) being one of marks to calculate a phase modulation quantity is important for light, and both film configurations of Tables 2 and 3 have almost the same value as optical thickness. To obtain the same characteristics as rugate filters by utilizing the equivalent film theory, each film configuring general rugate filters is regarded as an equivalent film (having refractive index n_{T}), and the equivalent film is replaced with films (mutually having refractive indexes n₁ and n₂) formed each of arbitrary two materials.

Besides, as illustrated in FIG. 2, from the supporting substrate 102 side to the incident substrate 101 side, the increase/decrease amounts of optical thickness of the first film preferably increases and then decreases (varies in such a way as small to large to small). In a rugate filter before being replaced as the equivalent film, a variation of the refractive index from the supporting substrate 102 side to the incident substrate 101 side gradually increases and then, converges. This variation of the refractive index is necessary to suppress the previous described ripples. According to equivalent film conversion using the expressions (2) to (6), this is equivalent to stacking the thin films 502, 503 and 504 while varying a rate of optical thickness of the thin films 502, 503 and 504.

FIG. 8 illustrates optical thickness when each film is converted into an equivalent film using the expressions (2) to (6). Herein, the material of the thin films 502 and 504 is Ta₂O₅, and the material of the thin film 503 is MgF₂. Optical thickness of Ta₂O₅ is each optical thickness of the thin films 502 and 504. The inventor discovered modulating a refractive index in rugate filters is almost equivalent to modulating optical thickness in an equivalent film.

The following presents a ratio of optical thickness of each equivalent film in FIG. 8 to the central wavelength λ_{d}.

equivalent film 1:0.087H,0.067M, equivalent film 2: 0.081H,0.08M, equivalent film 3: 0.096H,0.052M, equivalent film 4: 0.074H,0.094M, equivalent film 5: 0.1H,0.045M, equivalent film 6: 0.067H,0.108M, equivalent film 7: 0.104H,0.038M, equivalent film 8: 0.058H,0.125M, equivalent film 9: 0.108H,0.031M, equivalent film 10: 0.049H,0.145M, equivalent film 11: 0.112H,0.024M, equivalent film 12: 0.037H,0.17M, equivalent film 13: 0.115H,0.018M, equivalent film 14: 0.018H,0.209M, equivalent film 15: 0.119H,0.011M, equivalent film 16: 0.018H,0.209M, equivalent film 17: 0.122H,0.005M, equivalent film 18: 0.018H,0.209M, equivalent film 19: 0.125H,0.002M, equivalent film 20: 0.018H,0.209M, equivalent film 21: 0.123H,0.003M, equivalent film 22: 0.018H,0.209M, equivalent film 23: 0.121H,0.008M, equivalent film 24: 0.018H,0.209M, equivalent film 25: 0.118H,0.012M, equivalent film 26: 0.018H,0.209M, equivalent film 27: 0.116H,0.017M, equivalent film 28: 0.018H,0.209M, equivalent film 29: 0.113H,0.021M, equivalent film 30: 0.018H,0.209M, equivalent film 31: 0.111H,0.026M, equivalent film 32: 0.035H,0.174M, equivalent film 33: 0.108H,0.031M, equivalent film 34: 0.046H,0.151M, equivalent film 35: 0.105H,0.036M, equivalent film 36: 0.055H,0.132M, equivalent film 37: 0.102H,0.041M, equivalent film 38: 0.063H,0.117M, equivalent film 39: 0.1H,0.046M, equivalent film 40: 0.07H,0.103M, equivalent film 41: 0.097H,0.051M, equivalent film 42: 0.076H,0.09M, equivalent film 43: 0.094H,0.057M, equivalent film 44: 0.082H,0.079M, equivalent film 45: 0.091H,0.062M, equivalent film 46: 0.088H,0.068M, equivalent film 47: 0.088H,0.068M.

When the equivalent films are stacked, optical thickness of the H-H films intermediate between HMH-HMH of successionally stacked equivalent films can be combined. FIG. 2 is a result obtained by performing this combination in the film configuration of FIG. 8. In other words, when three thin films 502 to 504 of FIG. 5 are repeatedly stacked, the optical thickness of the thin film 503 remains and the optical thickness of the thin films 502 and 504 are combined with adjacent thin films. According to results of combination, the thin films 502 and 504 have similar optical thickness and the increase/decrease amounts decrease.

In this embodiment, a film (the other film) that is not the first film of the H-film and the M-film is a second film. Optical thickness of the second film also repeats an increase/decrease from the supporting substrate 102 side to the incident substrate 101 side, but increase/decrease amounts of the optical thickness of the second film is equal to or less than half of that of the first film. This feature is a condition 3.

In the first embodiment, as illustrated in FIG. 2, the optical thickness of the H-film being the second film relative to the M-film being the first film is enormously small. A maximum value of the increase/decrease amounts of the optical thickness of the H-film calculated by the method explained using FIG. 4 is 6.5 nm among the film numbers 23, 25 and 27, and is equal to or less than half of that (122.8 nm) of the M-film. Thus, the condition 3 is satisfied.

Herein, though the increase/decrease amounts of the optical thickness is simply explained, essence as the embodiment of the present invention is that rugate filters can be expressed using the equivalent film expressed by the expressions (2) to (6). Thus, the optical element adding or deleting films that lack functions as an optical thin film is not excluded from the embodiment of the present invention. For example, in the case of the use wavelength of λ, when a film whose optical thickness is equal to or less than λ/10 is individually or independently plurally formed off periodicity of peripheral films or is arranged in proximity to each substrate (101 and 102), calculating an increase/decrease amount including them is meaningless. Observing a multi-layer film having a certain degree of periodicity is required to evaluate increase/decrease amounts of optical thickness of the multi-layer film portion 103. Conversely, providing a multi-layer film having functions different from functions of rugate filters such as antireflection and phase adjustment closely to the multi-layer film portion 103 is effective. In this case, converting to increase/decrease amounts of optical thickness of part of a multi-layer film having functions of rugate filters is required. As illustrated in FIG. 2, presence or absence of functions can be determined whether or not an increase/decrease of optical thickness relative to film numbers is in a range of at least 5 cycles or more and 3000 cycles or less.

Additionally, it is desirable that the M-film is used as the first film. As illustrated in FIG. 6, dispersion of refractive index of the thin film (equivalent film) 512 obtained using the expressions (2) to (6) varies according to the refractive index of the first film. Though the refractive index and the physical thickness are the same in the use central wavelength λ_{d} (=600 nm), negative dispersion decreasing refractive index is generated in accordance with shortening of the wavelength when the M-film is the first film, and positive dispersion increasing refractive index is generated in accordance with shortening of the wavelength when the H-film is the first film. The thin films 502, 503 and 504 configuring the equivalent film 512 respectively have positive dispersion as shown in Table 1.

Meanwhile, in the extended equivalent film theory expressed by the expressions (2) to (6), the basic film configuration has negative dispersion when being HMH as shown in Table 2 and positive dispersion when being MHM as shown in Table 3. When a material having positive dispersion is converted into equivalent film using the theory expressed by the expressions (2) to (6), dispersion of the equivalent film crossing dispersion due to the film configuration (hereinafter referred to as “film configuration dispersion”) and dispersion due to materials (hereinafter referred to as “material dispersion”) is obtained. The film configuration of MHM as shown in Table 3 has positive dispersion of the film configuration dispersion and the material dispersion and thus, has extremely high positive dispersion. Whereas, since the film configuration of HMH as shown in Table 2 has negative dispersion of the film configuration dispersion and positive dispersion of the material dispersion, they are mutually offset and the film configuration has relatively low negative dispersion.

In a filter requiring to be multilayered like rugate filters, refractive index dispersion relative to a wavelength should be possibly suppressed. As shown in FIG. 6 and Tables 2 and 3, physical thickness of each film of Tables 2 and 3 varies according to the refractive index n_{T} and thus, film configuration dispersion is enormously large. Accordingly, the film configuration of HMH in which dispersion is offset relation is desirably selected as the first film.

Applying this theory usually controls optical thickness of the M-film to λ/3 or less and optical thickness of the H-film to λ/4 or less. Thus, when the M-film is the first film, it is desirable that optical thickness of the M-film is set to λ/3 or less and optical thickness of the H-film is set to λ/4 or less. This condition is a condition 4.

Moreover, in this embodiment, physical thickness desirably decreases with increasing increase/decrease amounts of optical thickness of the M-film. This condition is a condition 5. Increasing increase/decrease amounts of optical thickness corresponds to greatly varying variations of refractive index in rugate filters. According to the expressions (2) to (6), with respect to variation of the refractive index n_{T}, variation of n₂×d₂ representing optical thickness of the thin film 503 is smaller than that of n₁×d₁ representing optical thickness of the thin films 502 and 504. This is expressed in FIG. 8. In addition, regarding an increase/decrease of optical thickness of the thin films 502 and 504 in FIG. 8, decrease amounts of optical thickness are smaller than increase amounts of optical thickness. When the thin films 502 and 504 optically adjacent to each other are combined like FIG. 2, optical thickness is an addition value of upper and lower increase/decrease amounts. This means that, for example, the thin films 502 and 504 of an equivalent number of 5 in FIG. 8 are combined. Thus, physical thickness of the thin films 502 and 504 decreases.

In the first embodiment, the M-film being the first film is formed of MgF₂ and a maximum value of optical thickness of the M-film is 125.6 nm at an equivalent number of 36. When the use central wavelength λ_{d} is 600 nm, the maximum value of this optical thickness is equal to or less than λ_{d}/3 and thus, the condition 4 is satisfied. Furthermore, the H-film being the second film is formed of Ta₂O₅ and an maximum value of optical thickness of the H-film is 107.1 nm at a film number of 91. When the use central wavelength λ_{d} is 600 nm, the maximum value of this optical thickness is equal to or less than λ_{d}/4 and thus, the condition 5 is satisfied.

The multi-layer film 103 according to this embodiment satisfies the above conditions 1 to 5, and a reflection wavelength band in which reflectance relative to incident light incident at an incident angle of 0° is equal to or more than 80% desirably has a wavelength band width of λ/10 and λ/2. This condition is a condition 6. The multi-layer film portion 103 according to the first embodiment 1 has a wavelength band width of approximately λ_{d}/3 relative to the use central wavelength λ_{d} of 600 nm and satisfies the condition 6.

According to the first embodiment (and second to fourth embodiments described below), stacking two types of thin films respectively formed of two materials can obtain the same characteristics as rugate filters without using a film in which a refractive index serially varies.

### Second Embodiment

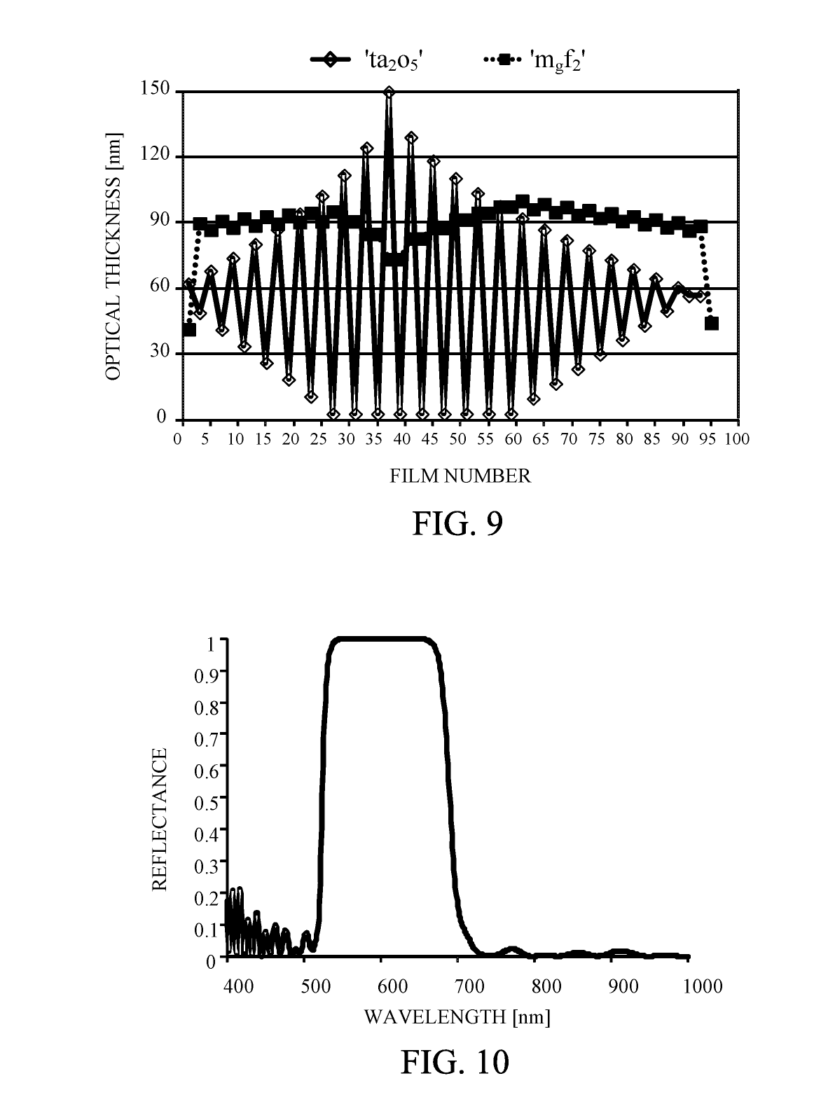

FIG. 9 illustrates a film configuration of a multi-layer film portion 103 of an optical element 100 according to a second embodiment and FIG. 10 illustrates reflectance characteristics. In this embodiment, an use central wavelength λ_{d} is 600 nm, an H-film and an M-film of the multi-layer film portion 103 are respectively formed of Ta₂O₅ and MgF₂. This embodiment differs from the first embodiment in that the H-film is used as a first film. As explained in the first embodiment, using the H-film as the first film makes film configuration dispersion positive. Thus, since both of film configuration dispersion and material dispersion of an equivalent film 512 are positive, refractive index dispersion of an equivalent film 512 is enormously highly positive dispersion. Using such a film makes refractive index dispersion larger and thus, large ripples at a short wavelength side of a reflection wavelength band of a rugate filter occurs. Though using a simple equivalent film generates such ripples, the optical element 100 according to this embodiment can be used in a wavelength band larger than a wavelength of 600 nm. Thus, a film configuration of the multi-layer film portion 103 according to this embodiment may be selected.

The following presents a ratio of optical thickness of each equivalent film in FIG. 9 to the central wavelength λ_{d}.

0.095M,0.228H,0.207M,0.179H,0.2M,0.249H,0.209M,0.151H,0.202M,0.271H,0.212M,0.123H,0.204M,0.294H,0.214M,0.096H,0.206M,0.318H,0.216M,0.068H,0.208M,0.345H,0.218M,0.039H,0.209M,0.374H,0.219M,0.01H,0.209M,0.409H,0.209M,0.01H,0.196M,0.455H,0.196M,0.01H,0.169M,0.548H,0.169M,0.01H,0.191M,0.472H,0.191M,0.01H,0.202M,0.433H,0.202M,0.01H,0.21M,0.404H,0.21M,0.01H,0.218M,0.379H,0.218M,0.01H,0.224M,0.357H,0.224M,0.01H,0.23M,0.337H,0.221M,0.036H,0.227M,0.318H,0.218M,0.061H,0.224M,0.301H,0.215M,0.085H,0.221M,0.284H,0.212M,0.11H,0.217M,0.268H,0.209M,0.134H,0.214M,0.252H,0.206M,0.158H,0.211M,0.237H,0.203M,0.182H,0.207M,0.222H,0.199M,0.207H,0.204M,0.207H,0.102M.

A maximum value and a minimum value of increase/decrease amounts of optical thickness of the H-film being the first film according to this embodiment are respectively 136.8 nm among film numbers of 38, 40 and 42, and 7.4 nm among film numbers of 88, 90 and 92. Relative to the use central wavelength λ_{d} of 600 nm, the minimum value is equal to or less than λ_{d}/15 and the maximum value is equal to or more than λ_{d}/10. Besides, total film number is 95. Accordingly, this embodiment satisfies not only conditions 1 and 2 but also conditions 3 to 6.

### Third Embodiment

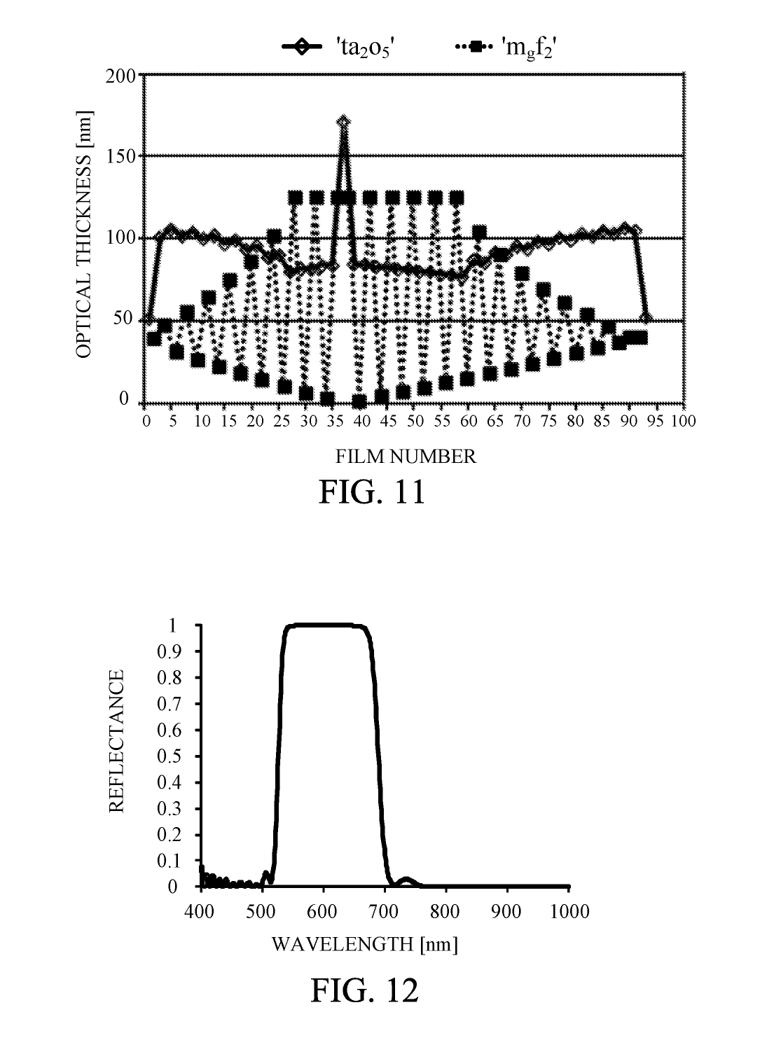

FIG. 11 illustrates a film configuration of a multi-layer film portion 103 of an optical element 100 according to a third embodiment and FIG. 12 illustrates reflectance characteristics. In this embodiment, an use central wavelength λ_{d} is 600 nm, an H-film and an M-film of the multi-layer film portion 103 are respectively formed of Ta₂O₅ and MgF₂. In this embodiment, thickness of a thin film of a film number of 38 in the first embodiment is 0 nm. A thin film having minute thickness following design of a rugate filter is treated as an effective thin film in the first embodiment, but a thin film that physical thickness is equal to or less than 5 nm or optical thickness is equal to or less than 10 nm does not greatly influence optical characteristics. Thus, if the above thin film is eliminated, a filter having the same function as a rugate filter can be obtained as illustrated in FIG. 12.

The following presents a ratio of optical thickness of each equivalent film in FIG. 11 to the central wavelength λ_{d}.

0.087H,0.067M,0.168H,0.08M,0.177H,0.052M,0.17H,0.094M,0.175H,0.045M,0.167H,0.108M,0.171H,0.038M,0.162H,0.125M,0.166H,0.031M,0.156H,0.145M,0.16H,0.024M,0.148H,0.17M,0.152H,0.018M,0.134H,0.209M,0.137H,0.011M,0.137H,0.209M,0.141H,0.005M,0.141H,0.209M,0.287H,0.209M,0.142H,0.003M,0.142H,0.209M,0.139H,0.008M,0.139H,0.209M,0.137H,0.012M,0.137H,0.209M,0.134H,0.017M,0.134H,0.209M,0.132H,0.021M,0.132H,0.209M,0.129H,0.026M,0.145H,0.174M, 0.143H,0.031M,0.154H,0.151M,0.151H,0.036M,0.16H,0.132M, 0.157H,0.041M,0.165H,0.117M,0.162H,0.046M,0.169H,0.103M, 0.166H,0.051M,0.173H,0.09M,0.17H,0.057M,0.176H,0.079M, 0.173H,0.062M,0.179H,0.068M,0.175H,0.068M,0.088M.

Meanwhile, since thickness of the thin film of the film number of 38 in the first embodiment is 0 nm, thick optical thickness projected by summing optical thickness of films of the film numbers 37 and 39 is formed as illustrated in FIG. 11. If part of optical thickness is abnormal, the multi-layer film is not eliminated from the embodiments of the present invention as long as the multi-layer film totally has the same function as a rugate filter as illustrated in FIG. 12. In other words, having part that includes a normal periodicity such as film of film numbers 1 to 30 and 60 to 95 except for abnormal part and contributes to obtain the same function as a rugate filter eliminating, the multi-layer filter is included in the embodiments of the present invention.

### Fourth Embodiment

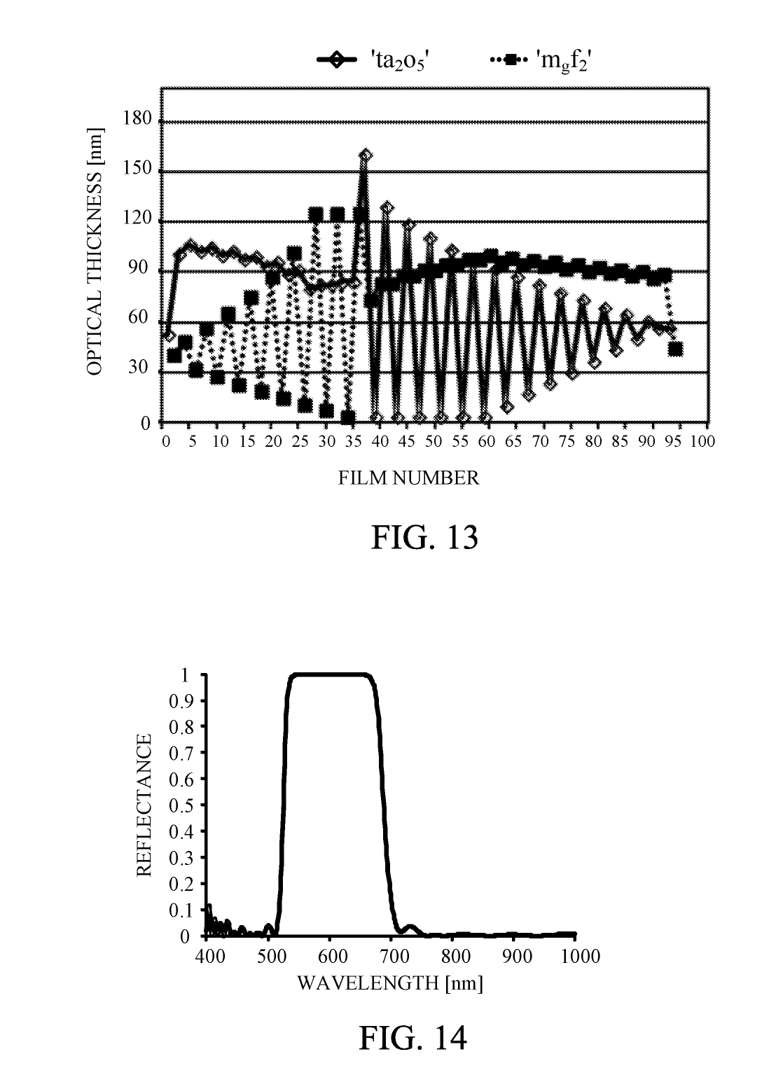

FIG. 13 illustrates a film configuration of a multi-layer film portion 103 of an optical element 100 according to a fourth embodiment and FIG. 14 illustrates reflectance characteristics. In this embodiment, an use central wavelength λ_{d} is 600 nm, an H-film and an M-film of the multi-layer film portion 103 are respectively formed of Ta₂O₅ and MgF₂. In this embodiment, at a thin film of a film number 38 as a boundary, the M-film is used as a first film on a small film number side and the H-film is used as the first film on a large film number side. Since the thin film having the same refractive index can be realized, the first film may be switched in a thickness direction (lamination direction) in the multi-layer film portion 103.

The following presents a ratio of optical thickness of each equivalent film in FIG. 13 to the central wavelength λ_{d}.

0.087H,0.067M,0.168H,0.08M,0.177H,0.052M,0.17H,0.094M,0.175H,0.045M,0.167H,0.108M,0.171H,0.038M,0.162H,0.125M,0.166H,0.031M,0.156H,0.145M,0.16H,0.024M,0.148H,0.17M,0.152H,0.018M,0.134H,0.209M,0.137H,0.011M,0.137H,0.209M,0.141H,0.005M,0.141H,0.209M,0.268H,0.122M,0.005H,0.138M,0.215H,0.138M,0.005H,0.146M,0.197H,0.146M,0.005H,0.152M,0.184H,0.152M,0.005H,0.158M,0.173H,0.158M,0.005H,0.162M,0.163H,0.162M,0.005H,0.167M,0.154H,0.16M,0.016H,0.164M,0.145H,0.158M,0.028H,0.162M,0.137H,0.156M, 0.039H,0.16M,0.129H,0.154M,0.05H,0.157M,0.122H,0.151M,0.061H,0.155M,0.115H,0.149M,0.072H,0.153M,0.108H,0.147M, 0.083H,0.15M,0.101H,0.144M,0.094H,0.148M,0.094M,0.074M.

As can be expected from FIG. 14, the multi-layer film according to this embodiment having the same function as the first and third embodiments can be realized.

As mentioned above, stacking two materials in the thickness direction can realize multi-layer film having the same characteristics as a rugate filter.

### Fifth Embodiment

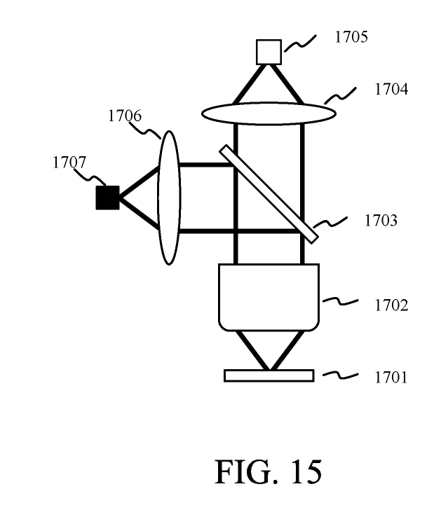

FIG. 15 illustrates a configuration of a fluorescence microscope as an example of optical apparatuses using the optical element 100 according to the first to fourth embodiments. Reference numeral 1701 denotes an object (sample), and 1702 an objective lens. Reference numerals 1704 and 1706 denote condenser lenses, and 1705 light detection element. Reference numeral 1707 denotes a light emitting element. And reference numeral 1703 denotes an optical element having a rugate filter function explained in either of the first to fourth embodiments.

The condenser lens 1706 converts light from the light emitting element 1707 into parallel light, and the converted light enters the optical element 1703. The optical element 1703 has a function that reflects the light incident from the light emitting element 1707, and the reflected light by the optical element 1703 is focused onto the sample 1701 through the objective lens 1702.

Fluorescence generated by the light focused onto the sample 1701 is converted into parallel light through the objective lens 1702, and enters the optical element 1703. The fluorescence is light having a wavelength different from a wavelength of the incident light from the light emitting element 1707. Herein, a film configuration of a multi-layer film of the optical element 1703 is set so that a wavelength of the fluorescence is a transmissive wavelength band. The fluorescence transmitting the optical element 1703 is focused onto the light detection element 1705 through the condenser lens 1704, and is detected by the light detection element 1705.

When the optical element 1703 is arranged to tilt at 45° as explained in this embodiment, optical thickness of each thin film may be set for 45°, and when the optical element 1703 is arranged to tilt at the other angle, optical thickness of each thin film may be naturally set for the other angle.

In addition, the optical element according to each embodiment is can be applied not only to the fluorescence microscope but also to various optical apparatuses requiring a filter function to selectively perform reflection and transmission according to a wavelength of incident light.

According to each embodiment, the optical element capable of obtaining a favorable optical performance similar to a rugate filter can be realized by stacking two types of films respectively formed of two materials and adjusting optical thickness without requiring special methods and apparatuses.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-122941, filed on Jun. 18, 2015, which is hereby incorporated by reference herein in its entirety.

What is claimed is:

1. An optical element comprising:
a substrate; and
a multi-layer filter stacked on the substrate, and
wherein when, of two materials having mutually different refractive indexes, a film formed of a material having a higher refractive index is an H-film and a film formed of a material having a lower refractive index is an M-film, the multi-layer films includes a plurality of H-films and M-films, and
wherein when one of the H-film and the M-film is a first film and a wavelength of light incident to the multi-layer film is λ(nm), optical thickness of the first film repeats an increase/decrease so that an increase/decrease amount varies, a maximum value of the increase/decrease amount is equal to or more than λ/10, a minimum value of the increase/decrease amount is equal to or less than λ/15, and total film numbers of the H-film and the M-film are from 30 to 1000.

2. The optical element according to claim 1, wherein a width of the increase/decrease varies to decrease after an increase.

3. The optical element according to claim 1,
wherein optical thickness of a second film being the other of the H-film and the M-film repeats an increase/decrease so that an increase/decrease amount varies, and
wherein the increase/decrease amount of optical thickness of the second film is equal to or less than half of the increase/decrease amount of optical thickness of the first film.

4. The optical element according to claim 1, wherein the first film is the M-film.

5. The optical element according to claim 4, wherein optical thickness of the first film being the M-film is equal to or less than λ/3.

6. The optical element according to claim 4, wherein optical thickness of the H-film is equal to or less than λ/4.

7. The optical element according to claim 4, wherein physical thickness of the H-film decreases according to an increase of the increase/decrease amount of the first film being the M-film.

8. The optical element according to claim 1, wherein reflectance of the multi-layer film with respect to incident light incident at an incident angle of 0° is equal to or more than 80% in a wavelength band width of λ/10 to λ/2.

9. The optical element according to claim 1, wherein the first film is switched between the H-film and the M-film in a lamination direction of the multi-layer film.

10. The optical element according to claim 1, wherein the increase/decrease amount is an average of differences of optical thickness among three successive first films.

11. The optical element according to claim 1, wherein each optical thickness of the H-film and the M-film is alternately repeatedly increased or decreased.

12. An optical system comprising:
a plurality of optical elements,
wherein at least one of the optical elements includes a substrate and a multi-layer filter stacked on the substrate,
wherein when, of two materials having mutually different refractive indexes, a film formed of a material having a higher refractive index is an H-film and a film formed of a material having a lower refractive index is an M-film, the multi-layer films includes a plurality of H-films and M-films, and
wherein when one of the H-film and the M-film is a first film and a wavelength of light incident to the multi-layer film is λ(nm), optical thickness of the first film repeats an increase/decrease so that an increase/decrease amount varies, a maximum value of the increase/decrease amount is equal to or more than λ/10, a minimum value of the increase/decrease amount is equal to or less than λ/15, and total film numbers of the H-film and the M-film are from 30 to 1000.

13. An optical apparatus comprising:
an optical element; and
a light detection element that receives light from the optical element,
wherein at least one of the optical elements includes a substrate and a multi-layer filter stacked on the substrate,
wherein when, of two materials having mutually different refractive indexes, a film formed of a material having a higher refractive index is an H-film and a film formed of a material having a lower refractive index is an M-film, the multi-layer films includes a plurality of H-films and M-films, and
wherein when one of the H-film and the M-film is a first film and a wavelength of light incident to the multi-layer film is λ(nm), optical thickness of the first film repeats an increase/decrease so that an increase/decrease amount varies, a maximum value of the increase/decrease amount is equal to or more than λ/10, a minimum value of the increase/decrease amount is equal to or less than λ/15, and total film numbers of the H-film and the M-film are from 30 to 1000.
